(19) United States
(12) Patent Application Publication
(10) Pub. No.: US 2026/0082178 A1
(43) Pub. Date: Mar. 19, 2026

(54) GENERATION OF COMBINED LOCATION DATA FOR USER DEVICE LOCATION-BASED SERVICES

(71) Applicant: DISH Wireless L.L.C., Englewood, CO (US)

(72) Inventors: Mehdi Alasti, Herndon, VA (US); Raghavendhra Rao, Littleton, CO (US); Siddhartha Chenumolu, Ashburn, VA (US)

(21) Appl. No.: 18/886,417

(22) Filed: Sep. 16, 2024

(51) Int. Cl. H04W 4/029; H04W 4/90

(52) U.S. Cl. CPC H04W 4/029; H04W 4/90

(57) ABSTRACT

Systems and methods for generating optimal location data for a user device that is using a location-based service. Location data (e.g., horizontal location data, vertical location data, or a combination thereof) for the user device are obtained from multiple sources. A weight is generated for each corresponding source based on a location uncertainty for the corresponding source relative to a combined location uncertainty for the plurality of sources. Weighted location data is generated for each corresponding source based on a combination of the location data for the corresponding source and the weight for the corresponding source. Combined location data is then generated for the user device based on a combination of the weighted location data for the plurality of sources. The combined location data is set as the captured location data of the user device for the location-based service.

### BACKGROUND

Mobile phones are being used more and more by more and more people. As the use of mobile phones has increased, so too has the need to make 911 calls from mobile phones. The speed at which emergency services can respond to a 911 call relies on identifying the caller's location. Unfortunately, many callers are unable to provide their location. As a result, the Federal Communications Commission has required cellular service providers to obtain and provide the mobile phone's location to the emergency services within a certain level of accuracy. Similarly, many mobile phones have other applications or other services that rely on or use location information. But mobile phones can be unreliable in providing or obtaining accurate location information. It is with respect to these and other considerations that the embodiments described herein have been made.

### BRIEF SUMMARY

Embodiments are directed towards systems and methods for generating optimal location data for a user device that is using a location-based service. Location data (e.g., horizontal location data, vertical location data, or a combination thereof) for the user device are obtained from multiple sources. A weight is generated for each corresponding source based on a location uncertainty for the corresponding source relative to a combined location uncertainty for the plurality of sources. Weighted location data is generated for each corresponding source based on a combination of the location data for the corresponding source and the weight for the corresponding source. Combined location data is then generated for the user device based on a combination of the weighted location data for the plurality of sources. The combined location data is set as the captured location data of the user device for the location-based service. In general, the generation of combined location data, as described herein, can help mitigate effects of multipath location sources, which is often a common reason for errors in estimating locations indoors and outdoors.

In various embodiments, the weight, weighted location data, and combined location data are generated for different types of location data. For example, in some embodiments, a horizontal weight is generated for each corresponding source based on a horizontal location uncertainty for the corresponding source relative to a combined horizontal location uncertainty for the plurality of sources. Weighted horizontal location data is then generated for each corresponding source based on a combination of the horizontal location data for the corresponding source and the horizontal weight for the corresponding source. Combined horizontal location data is generated for the user device based on a combination of the weighted horizontal location data for the plurality of sources. In other embodiments, a vertical weight is generated for each corresponding source based on a vertical location uncertainty for the corresponding source relative to a combined vertical location uncertainty for the plurality of sources. Weighted vertical location data is then generated for each corresponding source based on a combination of the vertical location data for the corresponding source and the vertical weight for the corresponding source. Combined vertical location data is generated for the user device based on a combination of the weighted vertical location data for the plurality of sources.

By employing embodiments described herein, user devices can obtain optimal location data with an optimal location uncertainty, which are more accurate than relying on the location data from a single location source.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for generating combined location data from multiple location sources for location-based services of user devices (e.g., 911 calls) in accordance with embodiments described herein;

FIGS. 2A-2B illustrate a logical flow diagram showing one embodiment of a process for generating optimal horizontal location data from multiple location sources for location-based services of user devices in accordance with embodiments described herein;

FIG. 3 illustrates a logical flow diagram showing one embodiment of a process for generating optimal vertical location data from multiple location sources for location-based services of user devices in accordance with embodiments described herein; and

FIG. 4 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

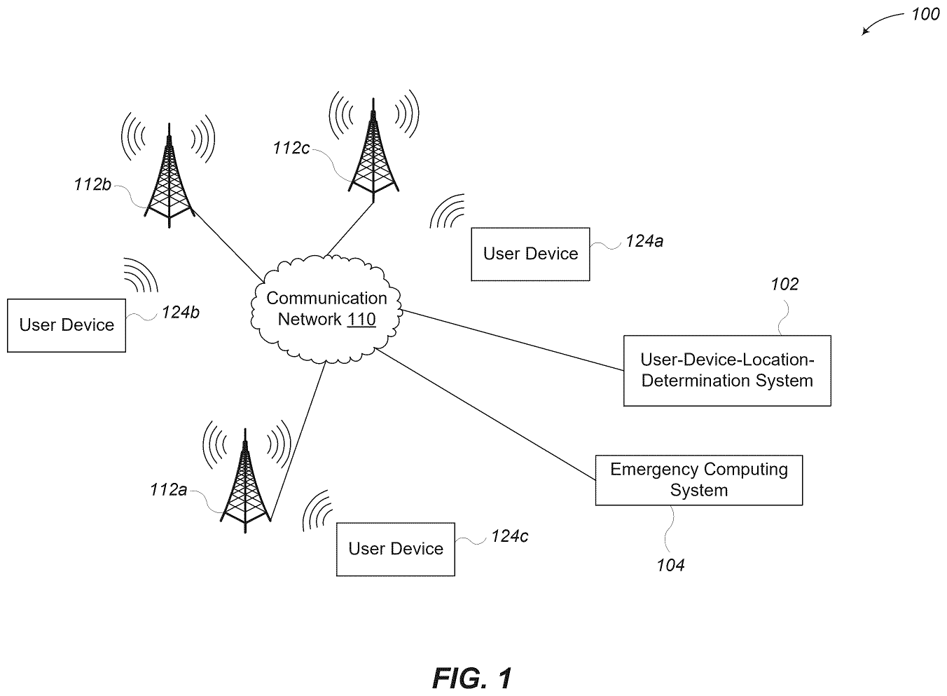

FIG. 1 illustrates a context diagram of an environment 100 for generating combined location data from multiple location sources for location-based services of user devices (e.g., 911 calls, asset trackers, navigation, or other location-based services) in accordance with embodiments described herein. Environment 100 includes a plurality of cells 112a-112c, a plurality of user devices 124a-124c, a user-device-location-determination system 102, and a communication network 110. In some embodiments, the user-device-location-determination system 102 is optional and not included in environment 100. In various embodiments, environment 100 may also include an emergency computing system 104.

The cells 112a-112c are cellular towers that together provide the hardware infrastructure of a cellular communications network, e.g., a 5G cellular communications network. The cells 112a-112c may include or be in communication with base stations, radio back haul equipment, antennas, or other devices, which are not illustrated for case of discussion. In various embodiments, the cells 112a-112c may communicate with each other via communication network 110. The cells 112a-112c may be individually or collectively referred to as cell 112 or cells 112. Communication network 110 includes one or more wired or wireless networks, which may include a series of smaller or private connected networks that carry information between the cells 112a-112c. In some embodiments, the cells 112a-112c and the communication network 110, along with other networking components not illustrated, may collectively be referred to as a wireless network or a cellular network that supports embodiments described herein.

Although embodiments described herein are discussed with respect to the use of cells and cellular communications networks, embodiments are not so limited. Rather, embodiments described herein can be used in non-cellular wireless communications networks or environments, such as Wi-Fi access points, Internet-of-Things (IOT) devices, or other situations where a user device has obtains location information from multiple location sources for a location-based service.

The user devices 124a-124c are computing devices that utilize at least one location-based services, devices, or systems, such as, but not limited to, 911 emergency services, law enforcement devices and tracking, gaming applications, social media applications, asset tracking, etc. User devices 124a-124c may be referred to as user devices, mobile devices, mobile computing devices, user mobile devices, user equipment, or some combination thereof, or other similar terminology. Examples of user devices 124a-124c may include, but are not limited to, mobile phones, smartphones, tablets, cellular-enabled laptop computers, RedCap devices, Internet-of-Things devices, or other computing devices that can utilize a location-based service. As one illustrative example, user devices 124a-124c may be mobile devices that are configured to receive and transmit cellular communications with the cells 112a-112c. The user devices 124a-124c may be individually or collectively referred to as user device 124 or user devices 124.

In various embodiments, the user devices 124a-124c may be configured to obtain location data from one or more location sources, whether from sources on the user devices or from network sources or a combination thereof, indicating a location of the user device when using a location-based service. The location data includes horizontal location data (x-axis horizontal location data or y-axis horizontal location data, or a combination thereof) and vertical location data (z-axis vertical location data). In various embodiments, the location data may also include horizontal location uncertainty and vertical location uncertainty data. In some embodiment, the horizontal location uncertainty may be the same for both x-axis horizontal location data and y-axis horizontal location data, as such the associated horizontal uncertainty may refer to both x/y horizontal location data. In other embodiments, x-axis horizontal location uncertainty for the x-axis horizontal location data may be separate from y-axis horizontal location uncertainty for the y-axis horizontal location data, although the x-axis horizontal location uncertainty may be the same value as or a different value from the y-axis horizontal location uncertainty.

When a location of the user device 124 is needed or requested for a location-based service, the user device 124 generates, determines, collects, or obtains location data from a plurality of location sources. The location data from one or more sources may include horizontal location data (the horizontal position of the user device on the Earth) or vertical location data (the altitude or elevation of the user device relative to the Earth), or a combination thereof. The location sources from which the location data is determined or obtained may include horizontal location sensors or systems that capture horizontal location data of a user device at the time of a use of the location-based service and vertical location sensors or systems to capture vertical location data of the user device at the time of the use of the location-based service. Accordingly, the location sources may include device-based positioning sources or network-based positioning methods, or a combination thereof. Examples of horizontal location sensors or systems may include, but are not limited to, Global Navigation Satellite System (GNSS) data (e.g., Global Positioning System (GPS), GLONASS, BeiDou, Galileo, Indian Regional Navigation Satellite System (IRNSS), Quasi-Zenith Satellite System (QZSS), WiFi, Bluetooth Low Energy (BLE), other horizonal positional sensors (e.g., accelerometers or gyroscopes), or the like), cell tower triangulation, cell identification (e.g., a location of the cell tower in which the user device is communicating), enhanced cell identification (e.g., a relative direction or distance from the location of the cell tower in which the user device is communicating and few neighboring cell towers in which the user device can measure their received power), or other systems configured to capture a horizontal location of a user device using the location-based service. Examples of vertical location sensors or systems may include, but are not limited to, Global Positioning System (GPS) data, Global Navigation Satellite System (GNSS) data (e.g., Global Positioning System (GPS), GLONASS, BeiDou, Galileo, Indian Regional Navigation Satellite System (IRNSS), Quasi-Zenith Satellite System (QZSS), WiFi, Bluetooth Low Energy (BLE), other vertical positional sensors (e.g., accelerometers or gyroscopes), barometric positioning sensors, or the like), barometric sensor, enhanced barometric sensor (e.g., biometric sensor data calibrated to the horizontal location of the user device or to the current weather at the horizontal location of the user device), crowdsourced data based on known Wi-Fi hot spots, RF finger-printing, beacons, vertical beamforming, or other systems configured to capture a vertical location of the user device using the location-based service. Other types of positioning features, capabilities and positioning methods may also be used to provide or enhance location data, including for example, downlink time difference of arrival (DL-TDoA), uplink time difference of arrival (UL-TDoA), multi-cell round-trip time (MC-RTT), downlink angle of departure (DL-AoD), uplink angle of arrival (UL-AoA), Carrier Phase, positioning reference units with a known position to the network, etc.

Accordingly, the location sources may be some combination of location sources on or employed by the user device 124 or determined by the user-device-location-determination system 102 separate or independent of the user devices, or a hybrid location system that utilizes a combination of information provided by the user devices and generated by the network. Thus, the user devices may generate and provide some location source data and the network (e.g., the user-device-location-determination system 102) may generate or determine other location source data (e.g., without the user device providing location data).

In some embodiments, the user devices 124a-124c are configured to transmit the location data indicating a location of the user device when using the location-based services. For example, in various embodiments, the user devices 124a-124c are configured to transmit the location data when initiating or making emergency calls to a 911 dispatcher or Public Safety Answering Point (PSAP) (not illustrated). As another example, the user devices 124a-124c are configured to transmit the location data to the user-device-location-determination system 102, which than then employ embodiments described herein to generate optimal or combined location data and provide that optimal location data back to the user devices. In other embodiments, the user devices 124a-124c are configured to employ embodiments described herein to generate optimal or combined location data for location-based services from the location data obtain from a plurality of location sources. In at least one such embodiment, the user devices 124a-124c can then cause the location-based service to use the optimal or combined location data as the captured location data for the user device (e.g., an application running on the user device can use the optimal location data as the location of the user device). In another such embodiment, the user devices 124a-124c can transmit the optimal or combined location data as the as the captured location data for the user device (e.g., the user device can transmit the optimal location data with an emergency call).

The user-device-location-determination system 102 is a computing device or cloud computing environment within the cellular communications network that is configured to employ embodiments described herein to generate optimal or combined location data for user devices 124a-124c. In some embodiments, a user device 124 may send a request (including the location data from multiple location sources) to the user-device-location-determination system 102 for optimal location data for that user device 124. The user-device-location-determination system 102 can then employ embodiments described herein to generate optimal or combined location data and provide that optimal or combined location data back to the user device 124 that requested the data.

In some embodiments, the user-device-location-determination system 102 may receive a request from the emergency computing system 104 for the optimal location data for a user device 124 that is making an emergency call. In other embodiments, the user-device-location-determination system 102 may itself initially receive the emergency call from the user device. The user-device-location-determination system 102 may obtain the multiple source location data from the request or from emergency call. The user-device-location-determination system 102 can then employ embodiments described herein to generate optimal or combined location data and provide that optimal or combined location data to the emergency computing system 104.

The emergency computing system 104 is a computing device or cloud computing environment within the cellular communications network that manages or coordinates emergency calls between user devices 124 and a 911 dispatcher or PSAP. Emergency calls, also referred to as 911 calls or e911 calls, are phone calls or messages, or other emergency communications, made from user devices 124 to a 911 dispatcher via the emergency computing system 104 of the cellular communication network. In some embodiments, the emergency computing system 104 operates as an intermediate for emergency calls between the user devices 124a-124c and the 911 dispatcher. In other embodiments, the emergency computing system 104 initially receives the emergency call, but transfers or hands off the emergency call to the 911 dispatcher, such that the emergency computing system 104 is not an intermediary during the remainder of the emergency call. In yet other embodiments, the emergency computing system 104 may transfer or hand off the emergency call to another 911 data-management computing system (not illustrated) to manage the emergency call between the user device 124 and the 911 dispatcher.

When an emergency call is made by a user device 124, the emergency computing system 104 receives the call and selects the appropriate PSAP. In various embodiments, the emergency computing system 104 determines the location of the user device 124, which is used to select the PSAP. Because the PSAP (or dispatcher) relies on the accuracy of this location data to quickly dispatch emergency services to the user device's location, the emergency computing system 104 also provides the user device's location to the PSAP. In some embodiments, the emergency computing system 104 receives the optimal or combined location data from the user device 124. In other embodiments, the emergency computing system 104 receives location data from the user device and queries the user-device-location-determination system 102 for the optimal or combined location data from the received location data. In yet other embodiments, the emergency computing system 104 may not receive any location data from the user device, but queries the user-device-location-determination system 102 to obtain the location data and generate the optimal or combined location data for the user. In some other embodiments, the user-device-location-determination system 102, not the emergency computing system 104, may initially receive the 911 call, determine the user device's optimal or combined location data, and then forward the call and the optimal or combined location data to the emergency computing system 104. Once received, the emergency computing system 104 can use the optimal or combined location data to select the appropriate PSAP for the emergency call. Moreover, emergency computing system 104 can provide the optimal or combined location data to the selected 911 dispatcher or PSAP.

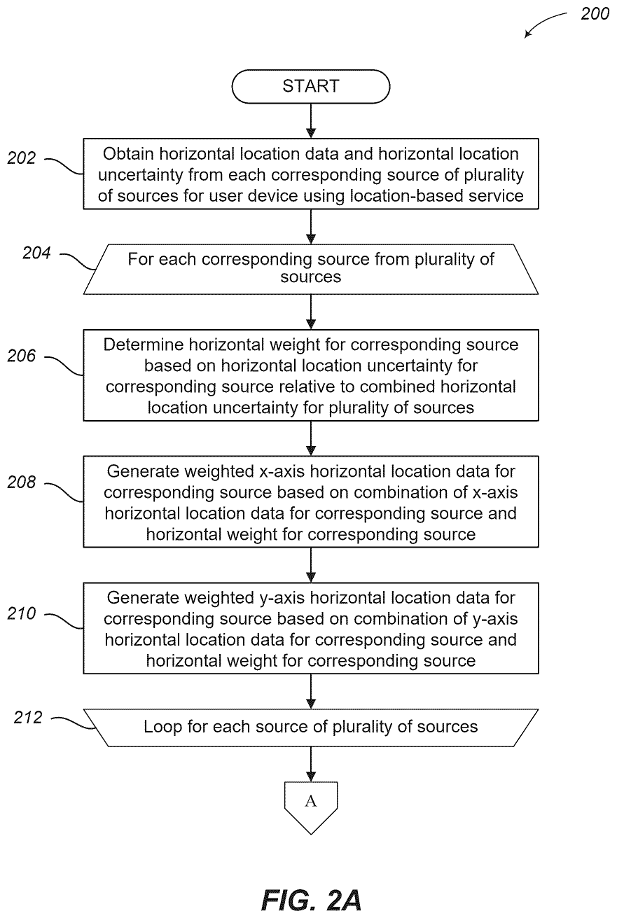

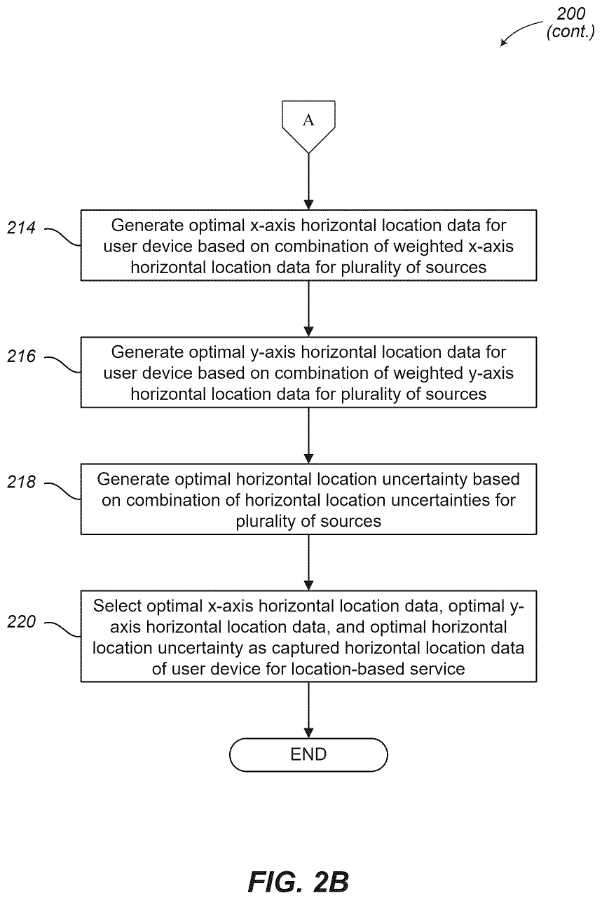

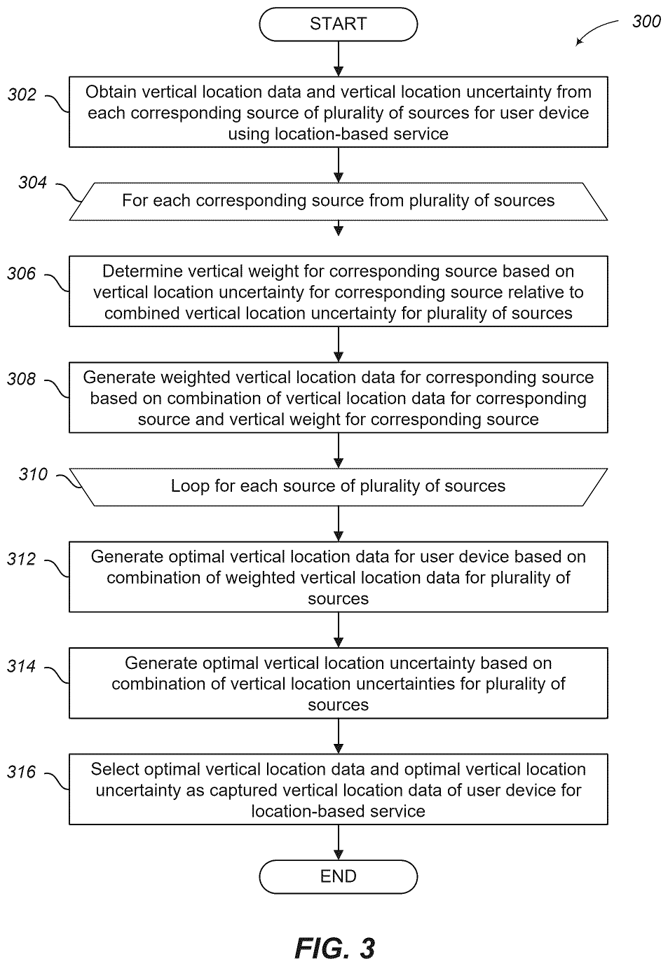

The operation of certain aspects will now be described with respect to FIGS. 2A-2B and FIG. 3. The functionality of processes 200 and 300 described in conjunction with FIGS. 2A-2B and 3, respectively, may be implemented by or executed via circuitry on one or more computing devices, such as user devices 124a-124c, the user-device-location-determination system 102, or the 911 computing system 104 in FIG. 1.

FIGS. 2A-2B illustrate a logical flow diagram showing one embodiment of a process 200 for generating optimal horizontal location data from multiple location sources for location-based services of user devices in accordance with embodiments described herein.

Process 200 begins, after at start block in FIG. 2A, at block 202, where horizontal location data and a horizontal location uncertainty are obtained from each corresponding location source of a plurality of location sources for a user device that is utilizing a location-based service (e.g., making a 911 call). The horizontal location data for a corresponding source may include a measured, calculated, or obtained corresponding horizontal location of the user device for that corresponding horizontal location data. As described herein, the location data may be generated and provided by location sources on or employed by the user device, or the location data may be generated or determined by the network itself, or generated using a hybrid system, or some combination thereof.

The horizontal location uncertainty is a distance value indicating how far off the horizontal location represented by the horizontal location data is from an actual horizontal location of the user device, or an estimate of how far off the corresponding source calculates the horizontal location to be from the actual horizontal location of the user device. In various embodiments, the horizontal location uncertainty is the same for the x-axis horizontal location and the y-axis horizontal location. But in some embodiments, the horizontal location uncertainty may include an x-axis horizontal location uncertainty and a separate y-axis horizontal location uncertainty, which may be the same or different.

Process 200 continues, after block 202, to block 204, where each corresponding location source is selected from the plurality of location sources to be processed.

For each corresponding source, process 200 proceeds, after block 204, to block 206, where a horizontal weight is determined for the corresponding source. In various embodiments, the horizontal weight is determined based on a horizontal location uncertainty for the corresponding source relative to a combined horizontal location uncertainty for the plurality of sources.

In some embodiments, the horizontal weight for the corresponding source may be determined by:

$${a}_{n} = \frac{\frac{1}{{σ}_{n}^{2}}}{{\sum }_{i = 1}^{K} \frac{1}{{σ}_{i}^{2}}} ,$$

where
n is the current corresponding source;
aₙ is the horizontal weight for the corresponding source n;
σₙ is the horizontal location uncertainty for the corresponding source n;
i is a given location source for the location-based service of the user device for K plurality of location data sources (where i=1, . . . , K);
σᵢ is the horizontal location uncertainty for the given location source i.

As noted above, in some embodiments, the horizontal location uncertainty may include an x-axis horizontal location uncertainty and a separate y-axis horizontal location uncertainty. In this situation, the same equation may be used to calculate an x-axis horizontal weight where σₙ is the x-axis horizontal location uncertainty for the corresponding source n and σᵢ is the x-axis horizontal location uncertainty for the given location source i. Similarly, the same equation may be used to calculate a y-axis horizontal weight where σₙ is the y-axis horizontal location uncertainty for the corresponding source n and σᵢ is the y-axis horizontal location uncertainty for the given location source i.

Process 200 proceeds, after block 206, to block 208, where weighted x-axis horizontal location data is generated for the corresponding source based on a combination of the x-axis horizontal location data for the correspondence source and the horizontal weight for the corresponding source (or the x-axis horizontal weight). The weighted x-axis horizontal location data for a corresponding source n may be represented as aₙXₙ, where aₙ is the horizontal weight and Xₙ is the x-axis horizontal location data.

Various mathematical or logical combining mechanisms may be employed to combine the x-axis horizontal location data for the correspondence source with the horizontal weight for the corresponding source. As one illustrative example, the weighted x-axis horizontal location data may be generated by multiplying the x-axis horizontal location data by the horizontal weight (e.g., multiplying a longitude position of the corresponding source by the horizontal weight).

Process 200 proceeds, after block 208, to block 210, where weighted y-axis horizontal location data is generated for the corresponding source based on a combination of the y-axis horizontal location data for the correspondence source and the horizontal weight for the corresponding source (or the x-axis horizontal weight). The weighted y-axis horizontal location data for a corresponding source n may be represented as aₙYₙ, where aₙ is the horizontal weight and Yₙ is the y-axis horizontal location data.

Various mathematical or logical combining mechanisms may be employed to combine the y-axis horizontal location data for the correspondence source with the horizontal weight for the corresponding source. As one illustrative example, the weighted y-axis horizontal location data may be generated by multiplying the y-axis horizontal location data by the horizontal weight (e.g., multiplying a latitude position of the corresponding source by the horizontal weight).

Process 200 continues, after block 210, at block 212, which loops to block 204 to process each corresponding location source to generate weighted x-axis horizontal location data and weighted y-axis horizontal location data for that corresponding location source.

After block 212, process 200 continues at block 214 in FIG. 2B.

At block 214, optimal x-axis horizontal location data is generated for the user device based on a combination of the weighted x-axis horizontal location data generated for each of the plurality of location sources. In some embodiments, the optimal x-axis horizontal location data may be referred to as combined x-axis horizontal location data.

In various embodiments, the optimal x-axis horizontal location data is the linear combination of the weighted x-axis horizontal location data generated for each of the plurality of location sources. In some embodiments, the optimal x-axis horizontal location data may be determined by:

$${X}^{*} = {a}_{1} {X}_{1} + {a}_{2} {X}_{2} + … + {a}_{K} {X}_{K} ,$$

where
X* is the optimal x-axis horizontal location data;
K is the plurality of location data sources;
aᵢ is the horizontal weight (or x-axis horizontal weight) for the corresponding source i; and
Xᵢ is the x-axis horizontal location data for the corresponding source i.

Process 200 continues, after block 214, at block 216, where optimal y-axis horizontal location data is generated for the user device based on a combination of the weighted y-axis horizontal location data generated for each of the plurality of location sources. In some embodiments, the optimal y-axis horizontal location data may be referred to as combined y-axis horizontal location data.

In various embodiments, the optimal y-axis horizontal location data is the linear combination of the weighted y-axis horizontal location data generated for each of the plurality of location sources. In some embodiments, the optimal y-axis horizontal location data may be determined by:

$${Y}^{*} = {a}_{1} {Y}_{1} + {a}_{2} {Y}_{2} + … + {a}_{K} {Y}_{K} ,$$

where
Y* is the optimal y-axis horizontal location data;
K is the plurality of location data sources;
aᵢ is the horizontal weight (or y-axis horizontal weight) for the corresponding source i; and
Yᵢ is the y-axis horizontal location data for the corresponding source i.

In some embodiments, the optimal x-axis horizontal location data and the optimal y-axis horizontal location data may be collectively referred to as the optimal horizontal location data.

Process 200 proceeds, after block 216, to block 218, where an optimal horizontal location uncertainty is generated for the optimal horizontal location data. The optimal horizontal location uncertainty is generated based on a combination of the horizontal location uncertainties for the plurality of location sources. In some embodiments, the optimal horizontal location uncertainty may be referred to as combined horizontal location uncertainty.

In some embodiments, the optimal horizontal location uncertainty may be determined by:

$${σ}^{*} = \sqrt{\frac{1}{{\sum }_{i = 1}^{K} \frac{1}{{σ}_{i}^{2}}}} ,$$

where
σ* is the optimal horizontal location uncertainty for the user device;
i is a given location source for the location-based service of the user device for K plurality of location data sources (where i=1, . . . , K); and
σᵢ is the horizontal location uncertainty for the corresponding source i;

As noted above, in some embodiments, the horizontal location uncertainty may include an x-axis horizontal location uncertainty and a separate y-axis horizontal location uncertainty. In this situation, the same equation may be used to calculate an optimal x-axis horizontal location uncertainty where σ* is the optimal x-axis horizontal location uncertainty for the user device and σᵢ is the x-axis horizontal location uncertainty for the given location source i. Similarly, the same equation may be used to calculate an optimal y-axis horizontal location uncertainty where σ* is the y-axis horizontal location uncertainty for the user device and σᵢ is the y-axis horizontal location uncertainty for the given location source i.

Process 200 continues, after block 218, at block 220, where the optimal x-axis horizontal location data, the optimal y-axis location data, and the optimal horizontal location uncertainty (or the optimal x-axis horizontal location uncertainty and the optimal y-axis horizontal location uncertainty) are selected as the captured horizontal location data of the user device for the location-based service. This captured horizontal location data for the user device is the horizontal location data that is or would be used for or by the location-based service. For example, this captured horizontal location data may be provided to a 911 dispatcher as part of a 911 call. In some embodiments, this captured horizontal location data for the user device may be combined with other captured horizontal location data for other user devices to determine if the cellular communications network satisfies a required horizontal accuracy percentage for the location-based service (e.g., to determine if a plurality of 911 calls or simulated 911 calls achieve a threshold horizontal accuracy).

After block 220, process 200 terminates, or otherwise returns to a calling process to perform other actions.

FIG. 3 illustrates a logical flow diagram showing one embodiment of a process 300 for generating optimal vertical location data from multiple location sources for location-based services of user devices in accordance with embodiments described herein.

Process 300 begins, after at start block, at block 302, where vertical location data and a vertical location uncertainty are obtained from each corresponding location source of a plurality of location sources for a user device that is utilizing a location-based service (e.g., making a 911 call). In various embodiments, the vertical location data and the vertical location uncertainty may be obtained from the same plurality of location sources from which the horizontal location data and the horizontal location uncertainty are obtain in block 202 in FIG. 2.

The vertical location data for a corresponding source may include a measured, calculated, or obtained corresponding vertical location of the user device for that corresponding vertical location data. The vertical location uncertainty is a distance value indicating how far off the vertical location represented by the vertical location data is from an actual vertical location of the user device, or an estimate of how far off the corresponding source calculates the vertical location to be from the actual vertical location of the user device. As described herein, the location data may be generated and provided by location sources on or employed by the user device, or the location data may be generated or determined by the network itself, or generated using a hybrid system, or some combination thereof.

Process 300 continues, after block 302, to block 304, where each corresponding location source is selected from the plurality of location sources to be processed.

For each corresponding source, process 300 proceeds, after block 304, to block 306, where a vertical weight is determined for the corresponding source. In various embodiments, the vertical weight is determined based on a vertical location uncertainty for the corresponding source relative to a combined vertical location uncertainty for the plurality of sources.

In some embodiments, the vertical weight for the corresponding source may be determined by:

$${b}_{n} = \frac{\frac{1}{{ρ}_{n}^{2}}}{{\sum }_{i = 1}^{K} \frac{1}{{ρ}_{i}^{2}}} ,$$

where
n is the current corresponding source;
bₙ is the vertical weight for the corresponding source n;
ρₙ is the vertical location uncertainty for the corresponding source n;
i is a given location source for the location-based service of the user device for K plurality of location data sources (where i=1, . . . , K);
ρᵢ is the vertical location uncertainty for the given location source i.

Process 300 proceeds, after block 306, to block 308, where weighted vertical location data is generated for the corresponding source based on a combination of the vertical location data for the correspondence source and the vertical weight for the corresponding source. The weighted vertical location data for a corresponding source n may be represented as bₙZₙ, where bₙ is the vertical weight and Zₙ is the vertical location data.

Various mathematical or logical combining mechanisms may be employed to combine the vertical location data for the correspondence source with the vertical weight for the corresponding source. As one illustrative example, the weighted vertical location data may be generated by multiplying the vertical location data by the vertical weight (e.g., multiplying an altitude of the corresponding source by the vertical weight).

Process 300 proceeds, after block 308, to block 310, which loops to block 304 to process each corresponding location source to generate weighted vertical location data for that corresponding location source.

After block 310, process 300 continues at block 312, where optimal vertical location data is generated for the user device based on a combination of the weighted vertical location data generated for each of the plurality of location sources. In some embodiments, the optimal vertical location data may be referred to as combined vertical location data.

In various embodiments, the optimal vertical location data is the linear combination of the weighted vertical location data generated for each of the plurality of location sources. In some embodiments, the optimal vertical location data may be determined by:

$${Z}^{*} = {b}_{i} {Z}_{i} + {b}_{i + 1} {Z}_{i + 1} + … + {b}_{K} {Z}_{K} ,$$

where
Z* is the optimal vertical location data;
i is a given location source for the location-based service of the user device for K plurality of location data sources (where i=1, . . . , K);
bᵢ is the vertical weight for the corresponding source i; and
Zᵢ is the vertical location data for the corresponding source i.

Process 300 proceeds, after block 312, to block 314, where an optimal vertical location uncertainty is generated for the optimal vertical location data. The optimal vertical location uncertainty is generated based on a combination of the vertical location uncertainties for the plurality of location sources. In some embodiments, the optimal vertical location uncertainty may be referred to as combined vertical location uncertainty.

In some embodiments, the optimal vertical location uncertainty may be determined by:

$${ρ}^{*} = \sqrt{\frac{1}{{\sum }_{i = 1}^{K} \frac{1}{{ρ}_{i}^{2}}}} ,$$

where
ρ* is the optimal vertical location uncertainty for the user device;
i is a given location source for the location-based service of the user device for K plurality of location data sources (where i=1, . . . , K); and
ρᵢ is the vertical location uncertainty for the corresponding source i;

Process 300 continues, after block 314, at block 316, where the vertical location data and the optimal vertical location uncertainty are selected as the captured vertical location data of the user device for the location-based service. This captured vertical location data for the user device is the vertical location data that is or would be used for or by the location-based service. For example, this captured vertical location data may be provided to a 911 dispatcher as part of a 911 call. In some embodiments, this captured vertical location data for the user device may be combined with other captured vertical location data for other user devices to determine if the cellular communications network satisfies a required vertical accuracy percentage for the location-based service (e.g., to determine if a plurality of 911 calls or simulated 911 calls achieve a threshold vertical accuracy).

After block 316, process 300 terminates, or otherwise returns to a calling process to perform other actions.

Although process 300 in FIG. 3 and process 200 in FIGS. 2A-2B are illustrated as separate processes, embodiments are not so limited. In some embodiments, process 300 and process 200 may be combined into a single process such that the vertical location data and the horizontal location data are processed for each corresponding source, followed by the generation of the optimal vertical location data and the optimal horizontal location data (including optimal x-axis horizontal location data and the optimal y-axis horizontal location data). As a result, the optimal vertical location data, the optimal vertical location uncertainty, the optimal horizontal location data, and the optimal horizontal location uncertainty are selected as the captured location data of the user device for the location-based services.

Moreover, although FIGS. 2A-2B and 3 illustrate the blocks, steps, and acts being performed in a specific order, embodiments are not so limited. Rather, one or more of the various blocks, steps, or acts may be performed in parallel or in a logical order other than what is illustrated.

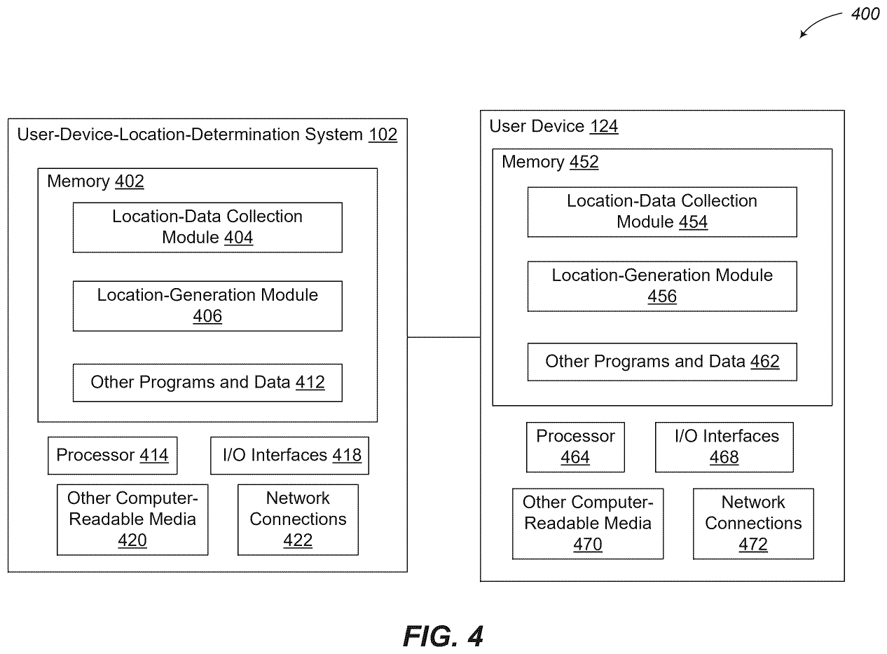

FIG. 4 shows a system diagram that describe various implementations of computing systems for implementing embodiments described herein. System 400 includes a user-device-location-determination system 102 and a user device 124, similar to what is illustrated in FIG. 1.

The user-device-location-determination system 102 is a computing system or environment that obtains, receives, or collects location data from a user device that is using a location-based service. In at least one embodiment, the user-device-location-determination system 102 may obtain, receive, or collect location data from a user device that making an emergency call. In some embodiments, the user-device-location-determination system 102 receives optimal or combined location data from the user device 124. In other embodiments, the user-device-location-determination system 102 obtains location data for the user device 124 from a plurality of sources and generates the optimal or combined location data for the user device, as described herein. The user-device-location-determination system 102 can then use the optimal or combined location data for the location-based services. For example, the user-device-location-determination system 102 can provide the optimal or combined location data to the emergency computing system 104, which then forwards the user device's emergency call and the optimal or combined location data to the appropriate PSAP. One or more special-purpose computing systems may be used to implement the optimal or combined location data. Accordingly, various embodiments described herein may be implemented in software, hardware, firmware, or in some combination thereof. The user-device-location-determination system 102 includes memory 402, processor 414, I/O interfaces 418, other computer-readable media 420, and network connections 422.

Processor 414 includes one or more processors, one or more processing units, programmable logic, circuitry, or one or more other computing components that are configured to perform embodiments described herein or to execute computer instructions to perform embodiments described herein. In some embodiments, a processor system of the user-device-location-determination system 102 may include a single processor 414 that operates individually to perform actions. In other embodiments, a processor system of the user-device-location-determination system 102 may include a plurality of processors 414 that operate to collectively perform actions, such that one or more processors 414 may operate to perform some, but not all, of such actions. Reference herein to “a processor system” of the user-device-location-determination system 102 refers to one or more processors 414 that individually or collectively perform actions. And reference herein to “the processor system” of the user-device-location-determination system 102 refers to 1) a subset or all of the one or more processors 414 comprised by “a processor system” and 2) any combination of the one or more processors 414 comprised by “a processor system” and one or more other processors 414.

Memory 402 may include one or more various types of non-volatile and/or volatile storage technologies. Examples of memory 402 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 402 may be utilized to store information, including computer-readable instructions that are utilized by processor 414 to perform actions, including embodiments described herein.

Memory 402 may have stored thereon location-data collection module 404 and location-generation module 406. The location-data collection module 404 is configured to receive or obtain location data from a plurality of location sources for user device 124. The location-generation module 406 is configured to generate optimal or combined location data from the obtained location data, as described herein. Although the location-data collection module 404 and the location-generation module 406 are illustrated as separate modules, embodiments are not so limited. Rather one module or a plurality of modules may be employed to perform the functionality of the location-data collection module 404 and the location-generation module 406. These modules may be software, hardware, or some combination thereof that together perform the functionality described herein. Moreover, one or more of these modules may be optional and may not be included depending on the functionality implemented by the user-device-location-determination system 102.

Memory 402 may also store other programs and data 412 (e.g., location data, operating systems, user device data, etc.)

Network connections 422 are configured to communicate with other computing devices, such as user device 124. In various embodiments, the network connections 422 include transmitters and receivers (not illustrated) to send and receive data as described herein. I/O interfaces 418 may include one or more data input or output interfaces, video or display interfaces, or other input/output interfaces. Other computer-readable media 420 may include other types of stationary or removable computer-readable media, such as removable flash drives, external hard drives, or the like.

The user device 124 is a computing system or environment that obtains, receives, or collects location data that is using a location-based service. In some embodiments, the user device 124 provides location data to other devices, such as user-device-location-determination system 102. In other embodiments, the user device 124 obtain location data from a plurality of sources and generates optimal or combined location data for the user device, as described herein. One or more special-purpose computing systems may be used to implement the user device 124. Accordingly, various embodiments described herein may be implemented in software, hardware, firmware, or in some combination thereof. The user device 124 includes memory 452, processor 464, I/O interfaces 468, other computer-readable media 470, and network connections 472.

Processor 464 includes one or more processors, one or more processing units, programmable logic, circuitry, or one or more other computing components that are configured to perform embodiments described herein or to execute computer instructions to perform embodiments described herein. In some embodiments, a processor system of the user device 124 may include a single processor 464 that operates individually to perform actions. In other embodiments, a processor system of the user device 124 may include a plurality of processors 464 that operate to collectively perform actions, such that one or more processors 464 may operate to perform some, but not all, of such actions. Reference herein to “a processor system” of the user device 124 refers to one or more processors 464 that individually or collectively perform actions. And reference herein to “the processor system” of the user device 124 refers to 1) a subset or all of the one or more processors 464 comprised by “a processor system” and 2) any combination of the one or more processors 464 comprised by “a processor system” and one or more other processors 464.

Memory 452 may include one or more various types of non-volatile and/or volatile storage technologies. Examples of memory 452 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 452 may be utilized to store information, including computer-readable instructions that are utilized by processor 414 to perform actions, including embodiments described herein.

Memory 452 may have stored thereon location-data collection module 454 and location-generation module 456. The location-data collection module 454 is configured to obtain location data from a plurality of location sources. The location-generation module 456 is configured to generate optimal or combined location data from the obtained location data, as described herein. Although the location-data collection module 454 and the location-generation module 456 are illustrated as separate modules, embodiments are not so limited. Rather one module or a plurality of modules may be employed to perform the functionality of the location-data collection module 454 and the location-generation module 456. These modules may be software, hardware, or some combination thereof that together perform the functionality described herein. Moreover, one or more of these modules may be optional and may not be included depending on the functionality implemented by the user device 124.

Memory 452 may also store other programs and data 462 (e.g., location data, operating systems, user device data, etc.)

Network connections 472 are configured to communicate with other computing devices, such as user-device-location-determination system 102 or emergency computing system 104. In various embodiments, the network connections 472 include transmitters and receivers (not illustrated) to send and receive data as described herein. I/O interfaces 468 may include one or more data input or output interfaces, video or display interfaces, or other input/output interfaces. Other computer-readable media 470 may include other types of stationary or removable computer-readable media, such as removable flash drives, external hard drives, or the like.

Although not illustrated, the emergency computing system 104 may include memory, processor, I/O interfaces, other computer-readable media, and network connections, similar to the user-device-location-determination system 102.

The following is a summarization of the original claims as filed.

A method may be summarized as comprising: obtaining, from a plurality of sources, horizontal location data and vertical location data of a user device using a location-based service via a wireless communications network; for each corresponding source of the plurality of sources: generating a horizontal weight for the corresponding source based on a horizontal location uncertainty for the corresponding source relative to a combined horizontal location uncertainty for the plurality of sources; generating weighted horizontal location data for the corresponding source based on a combination of the horizontal location data for the corresponding source and the horizontal weight for the corresponding source; generating a vertical weight for the corresponding source based on a vertical location uncertainty for the corresponding source relative to a combined vertical location uncertainty for the plurality of sources; and generating weighted vertical location data for the corresponding source based on a combination of the vertical location data for the corresponding source and the vertical weight for the corresponding source. The method may further include generating optimal horizontal location data for the user device based on a combination of the weighted horizontal location data for the plurality of sources; generating optimal vertical location data for the user device based on a combination of the weighted vertical location data for the plurality of sources; and setting the optimal horizontal location data and the optimal vertical location data as captured location data of the user device for the location-based service.

The method may further comprise: generating an optimal horizontal location uncertainty of the optimal horizontal location based on a combination of the horizontal location uncertainties for plurality of sources.

The method may further comprise: generating an optimal vertical location uncertainty of the optimal vertical location based on a combination of the vertical location uncertainties for plurality of sources.

The method may further comprise: generating an optimal horizontal location uncertainty of the optimal horizontal location based on a combination of the horizontal location uncertainties for plurality of sources; generating an optimal vertical location uncertainty of the optimal vertical location based on a combination of the vertical location uncertainties for plurality of sources; and setting the optimal horizontal location uncertainty and the optimal vertical location uncertainty as part of the captured location data of the user device for the location-based service.

The method may generate the weighted horizontal location data for the corresponding source by: generating weighted x-axis horizontal location data for the corresponding source based on a combination of x-axis horizontal location data for the corresponding source and the horizontal weight for the corresponding source; and generating weighted y-axis horizontal location data for the corresponding source based on a combination of y-axis horizontal location data for the corresponding source and the horizontal weight for the corresponding source. The method may generate the optimal horizontal location data for the user device by: generating optimal x-axis horizontal location data for the user device based on a combination of the weighted x-axis horizontal location data for the plurality of sources; and generating optimal y-axis horizontal location data for the user device based on a combination of the weighted y-axis horizontal location data for the plurality of sources.

The method may further comprise: causing the location-based service to use the captured location data of the user device.

The method may further comprise: forwarding the captured location data of the user device to emergency services as part of a 911 call made by the user device.

A computing device may be summarized as comprising: a memory configured to store computer instructions; and a processor system configured to execute the computer instructions to: obtain, from a plurality of sources, location data of a user device that is using a location-based service via a wireless communications network; for each corresponding source of the plurality of sources: generate a weight for the corresponding source based on a location uncertainty for the corresponding source; and generate weighted location data for the corresponding source based on a combination of the location data for the corresponding source and the weight for the corresponding source; generate combined location data for the user device based on a combination of the weighted location data for the plurality of sources; and set the combined location data as captured location data of the user device for the location-based service.

The processor system of the computing device may be configured to further execute the computer instructions to: generate a combined location uncertainty for the combined location data based on a combination of the location uncertainties for plurality of sources.

The processor system of the computing device may be configured to further execute the computer instructions to: generate a combined location uncertainty for the combined location data based on a combination of the location uncertainties for plurality of sources; and set the combined location uncertainty as part of the captured location data of the user device for the location-based service.

The processor system of the computing device may generate the weighted location data for the corresponding source by being configured to further execute the computer instructions to: generate weighted x-axis horizontal location data for the corresponding source based on a combination of x-axis horizontal location data for the corresponding source and the weight for the corresponding source; and generate weighted y-axis horizontal location data for the corresponding source based on a combination of y-axis horizontal location data for the corresponding source and the weight for the corresponding source. The processor system of the computing device may generate the combined location data for the user device by being configured to further execute the computer instructions to: generate combined x-axis horizontal location data for the user device based on a combination of the weighted x-axis horizontal location data for the plurality of sources; and generate combined y-axis horizontal location data for the user device based on a combination of the weighted y-axis horizontal location data for the plurality of sources.

The processor system of the computing device may generate the weighted location data for the corresponding source by being configured to further execute the computer instructions to: generate weighted vertical location data for the corresponding source based on a combination of vertical location data for the corresponding source and the weight for the corresponding source

The processor system of the computing device may generate the combined location data for the user device by being configured to further execute the computer instructions to: generate combined vertical location data for the user device based on a combination of the weighted vertical location data for the plurality of sources.

The processor system of the computing device may be configured to further execute the computer instructions to: cause the location-based service to use the captured location data of the user device.

The processor system of the computing device may be configured to further execute the computer instructions to: forward the captured location data of the user device to emergency services as part of a 911 call made by the user device.

A non-transitory computer-readable medium may be summarized as storing computer instructions that, when executed by at least one processor, cause the at least one processor to perform actions, the actions comprising: obtaining, from a plurality of sources, x-axis horizontal location data, y-axis horizontal location data, and vertical location data of a user device using a location-based service; for each corresponding source of the plurality of sources: generating weighted x-axis horizontal location data for the corresponding source based on a combination of the x-axis horizontal location data for the corresponding source and an x-axis horizontal weight for the corresponding source; generating weighted y-axis horizontal location data for the corresponding source based on a combination of the y-axis horizontal location data for the corresponding source and a y-axis horizontal weight for the corresponding source; and generating weighted vertical location data for the corresponding source based on a combination of the vertical location data for the corresponding source and the vertical weight for the corresponding source. The computer instructions, when executed by the at least one processor, may cause the at least one processor to perform further actions, the further actions comprising: generating optimal x-axis horizontal location data for the user device based on a combination of the weighted x-axis horizontal location data for the plurality of sources; generating optimal y-axis horizontal location data for the user device based on a combination of the weighted y-axis horizontal location data for the plurality of sources; generating optimal vertical location data for the user device based on a combination of the weighted vertical location data for the plurality of sources; and setting the optimal x-axis horizontal location data, the optimal x-axis horizontal location data, and the optimal vertical location data as captured location data of the user device for the location-based service.

The computer instructions, when executed by the at least one processor, cause the at least one processor to perform further actions, the further actions comprising: generating the x-axis horizontal weight for the corresponding source based on an x-axis horizontal location uncertainty for the corresponding source relative to a combined x-axis horizontal location uncertainty for the plurality of sources.

The computer instructions, when executed by the at least one processor, cause the at least one processor to perform further actions, the further actions comprising: generating the y-axis horizontal weight for the corresponding source based on a y-axis horizontal location uncertainty for the corresponding source relative to a combined y-axis horizontal location uncertainty for the plurality of sources.

The computer instructions, when executed by the at least one processor, cause the at least one processor to perform further actions, the further actions comprising: generating the vertical weight for the corresponding source based on a vertical location uncertainty for the corresponding source relative to a combined vertical location uncertainty for the plurality of sources.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining, from a plurality of sources, horizontal location data and vertical location data of a user device using a location-based service via a wireless communications network;
for each corresponding source of the plurality of sources:
generating a horizontal weight for the corresponding source based on a horizontal location uncertainty for the corresponding source relative to a combined horizontal location uncertainty for the plurality of sources;
generating weighted horizontal location data for the corresponding source based on a combination of the horizontal location data for the corresponding source and the horizontal weight for the corresponding source;
generating a vertical weight for the corresponding source based on a vertical location uncertainty for the corresponding source relative to a combined vertical location uncertainty for the plurality of sources; and
generating weighted vertical location data for the corresponding source based on a combination of the vertical location data for the corresponding source and the vertical weight for the corresponding source;
generating optimal horizontal location data for the user device based on a combination of the weighted horizontal location data for the plurality of sources;
generating optimal vertical location data for the user device based on a combination of the weighted vertical location data for the plurality of sources; and
setting the optimal horizontal location data and the optimal vertical location data as captured location data of the user device for the location-based service.

2. The method of claim 1, further comprising:
generating an optimal horizontal location uncertainty of the optimal horizontal location based on a combination of the horizontal location uncertainties for plurality of sources.

3. The method of claim 1, further comprising:
generating an optimal vertical location uncertainty of the optimal vertical location based on a combination of the vertical location uncertainties for plurality of sources.

4. The method of claim 1, further comprising:
generating an optimal horizontal location uncertainty of the optimal horizontal location based on a combination of the horizontal location uncertainties for plurality of sources;
generating an optimal vertical location uncertainty of the optimal vertical location based on a combination of the vertical location uncertainties for plurality of sources; and
setting the optimal horizontal location uncertainty and the optimal vertical location uncertainty as part of the captured location data of the user device for the location-based service.

5. The method of claim 1, wherein generating the weighted horizontal location data for the corresponding source comprises:
generating weighted x-axis horizontal location data for the corresponding source based on a combination of x-axis horizontal location data for the corresponding source and the horizontal weight for the corresponding source; and
generating weighted y-axis horizontal location data for the corresponding source based on a combination of y-axis horizontal location data for the corresponding source and the horizontal weight for the corresponding source.

6. The method of claim 5, wherein generating the optimal horizontal location data for the user device comprises:
generating optimal x-axis horizontal location data for the user device based on a combination of the weighted x-axis horizontal location data for the plurality of sources; and
generating optimal y-axis horizontal location data for the user device based on a combination of the weighted y-axis horizontal location data for the plurality of sources.

7. The method of claim 1, further comprising:
causing the location-based service to use the captured location data of the user device.

8. The method of claim 1, further comprising:
forwarding the captured location data of the user device to emergency services as part of a 911 call made by the user device.

9. A computing device, comprising:
a memory configured to store computer instructions; and
a processor system configured to execute the computer instructions to:
obtain, from a plurality of sources, location data of a user device that is using a location-based service via a wireless communications network;
for each corresponding source of the plurality of sources:
generate a weight for the corresponding source based on a location uncertainty for the corresponding source; and
generate weighted location data for the corresponding source based on a combination of the location data for the corresponding source and the weight for the corresponding source;
generate combined location data for the user device based on a combination of the weighted location data for the plurality of sources; and
set the combined location data as captured location data of the user device for the location-based service.

10. The computing device of claim 9, wherein the processor system is configured to further execute the computer instructions to:
generate a combined location uncertainty for the combined location data based on a combination of the location uncertainties for plurality of sources.

11. The computing device of claim 9, wherein the processor system is configured to further execute the computer instructions to:
generate a combined location uncertainty for the combined location data based on a combination of the location uncertainties for plurality of sources; and
set the combined location uncertainty as part of the captured location data of the user device for the location-based service.

12. The computing device of claim 9, wherein the processor system generates the weighted location data for the corresponding source by being configured to further execute the computer instructions to:
generate weighted x-axis horizontal location data for the corresponding source based on a combination of x-axis horizontal location data for the corresponding source and the weight for the corresponding source; and
generate weighted y-axis horizontal location data for the corresponding source based on a combination of y-axis horizontal location data for the corresponding source and the weight for the corresponding source.

13. The computing device of claim 12, wherein the processor system generates the combined location data for the user device by being configured to further execute the computer instructions to:
generate combined x-axis horizontal location data for the user device based on a combination of the weighted x-axis horizontal location data for the plurality of sources; and
generate combined y-axis horizontal location data for the user device based on a combination of the weighted y-axis horizontal location data for the plurality of sources.

14. The computing device of claim 9, wherein the processor system generates the weighted location data for the corresponding source by being configured to further execute the computer instructions to:
generate weighted vertical location data for the corresponding source based on a combination of vertical location data for the corresponding source and the weight for the corresponding source

15. The computing device of claim 14, wherein the processor system generates the combined location data for the user device by being configured to further execute the computer instructions to:
generate combined vertical location data for the user device based on a combination of the weighted vertical location data for the plurality of sources.

16. The computing device of claim 9, wherein the processor system is configured to further execute the computer instructions to:
cause the location-based service to use the captured location data of the user device.

17. The computing device of claim 9, wherein the processor system is configured to further execute the computer instructions to:
forward the captured location data of the user device to emergency services as part of a 911 call made by the user device.

18. A non-transitory computer-readable medium storing computer instructions that, when executed by at least one processor, cause the at least one processor to perform actions, the actions comprising:
obtaining, from a plurality of sources, x-axis horizontal location data, y-axis horizontal location data, and vertical location data of a user device using a location-based service;
for each corresponding source of the plurality of sources:
generating weighted x-axis horizontal location data for the corresponding source based on a combination of the x-axis horizontal location data for the corresponding source and an x-axis horizontal weight for the corresponding source;
generating weighted y-axis horizontal location data for the corresponding source based on a combination of the y-axis horizontal location data for the corresponding source and a y-axis horizontal weight for the corresponding source; and
generating weighted vertical location data for the corresponding source based on a combination of the vertical location data for the corresponding source and a vertical weight for the corresponding source;
generating optimal x-axis horizontal location data for the user device based on a combination of the weighted x-axis horizontal location data for the plurality of sources;
generating optimal y-axis horizontal location data for the user device based on a combination of the weighted y-axis horizontal location data for the plurality of sources;
generating optimal vertical location data for the user device based on a combination of the weighted vertical location data for the plurality of sources; and
setting the optimal x-axis horizontal location data, the optimal x-axis horizontal location data, and the optimal vertical location data as captured location data of the user device for the location-based service.

19. The non-transitory computer-readable medium of claim 18, wherein the computer instructions, when executed by the at least one processor, cause the at least one processor to perform further actions, the further actions comprising:
generating the x-axis horizontal weight for the corresponding source based on an x-axis horizontal location uncertainty for the corresponding source relative to a combined x-axis horizontal location uncertainty for the plurality of sources.

20. The non-transitory computer-readable medium of claim 18, wherein the computer instructions, when executed by the at least one processor, cause the at least one processor to perform further actions, the further actions comprising:
generating the y-axis horizontal weight for the corresponding source based on a y-axis horizontal location uncertainty for the corresponding source relative to a combined y-axis horizontal location uncertainty for the plurality of sources.

21. The non-transitory computer-readable medium of claim 18, wherein the computer instructions, when executed by the at least one processor, cause the at least one processor to perform further actions, the further actions comprising:
generating the vertical weight for the corresponding source based on a vertical location uncertainty for the corresponding source relative to a combined vertical location uncertainty for the plurality of sources.
